(19) United States
(12) Patent Application Publication
(10) Pub. No.: US 2014/0074279 A1
(43) Pub. Date: Mar. 13, 2014

(54) COMPUTER NUMERICAL CONTROLLED MACHINE TOOL CONTROL SYSTEM

(71) Applicant: Alan J. WEST, Camarillo, CA (US)

(72) Inventor: Alan J. WEST, Camarillo, CA (US)

(73) Assignee: HAAS AUTOMATION, INC., Oxnard, CA (US)

(21) Appl. No.: 13/606,987

(22) Filed: Sep. 7, 2012

(51) Int. Cl. G05B 19/18

(52) U.S. Cl. 700/159

(57) ABSTRACT

Systems and methods for interfacing a portable control system (PCS) with a machine tool are provided. In some aspects, a computer numerical controlled (CNC) machine tool includes a machine tool having a motor, a machine control system (MCS), and a motor controller. The MCS is configured to generate program status data associated with a machining program run by the MCS. The motor controller is configured to generate feedback data associated with the motor. The CNC machine tool also includes a port system configured to couple a PCS to the machine tool. The port system is configured to detect when the PCS is coupled to the machine tool and to provide at least one of the program status data and the feedback data to the PCS in response to the detection of the PCS being coupled to the machine tool.

### FIELD

The subject technology generally relates to computer numerical controlled (CNC) machine tools and, in particular, relates to an approach for interfacing CNC machine tools with a portable control system (PCS).

### BACKGROUND

Machine tools are power-operated tools used for finishing or shaping parts. Machine tools may operate by removing material from a workpiece. Basic machining operations include turning, facing, milling, drilling, boring, broaching, threading, and tapping. In addition, other operations may include sawing, grinding, gear cutting, polishing, buffing, and honing.

Computer numerical controlled (CNC) machine tools may be operated by programmed commands stored in or entered into the CNC machine tool. A control system, which includes a user interface, is used to enter the programmed commands into the CNC machine tool. The control system also provides network functionality, displays data, performs calculations, runs simulations, and handles other computationally intensive operations. However, the control system is an expensive component that drives up the cost of the CNC machine tool. This expense is amplified if multiple CNC machine tools are needed, since each of the CNC machine tools would need its own control system.

### SUMMARY

According to various aspects of the subject technology, a computer numerical controlled (CNC) machine tool is provided. The CNC machine tool comprises a machine tool having a motor, a machine control system (MCS), and a motor controller. The MCS is configured to generate program status data associated with a machining program run by the MCS. The motor controller is configured to generate feedback data associated with the motor. The CNC machine tool also comprises a port system configured to couple a portable control system (PCS) to the machine tool. The port system is configured to detect when the PCS is coupled to the machine tool and to provide at least one of the program status data and the feedback data to the PCS in response to the detection of the PCS being coupled to the machine tool.

According to various aspects of the subject technology, a CNC machine tool is provided. The CNC machine tool comprises a machine tool having an MCS. The CNC machine tool also comprises a PCS configured to generate a machining program run by the MCS. The MCS is configured to generate program status data associated with the machining program. The CNC machine tool also comprises a port system configured to couple the PCS to the machine tool. The port system is configured to detect when the PCS is coupled to the machine tool and to provide the program status data to the PCS in response to the detection of the PCS being coupled to the machine tool.

According to various aspects of the subject technology, a method for interfacing a PCS with a machine tool is provided. The method comprises detecting a coupling between the PCS and the machine tool. The machine tool includes a motor, a machine control system (MCS), and a motor controller. The method also comprises receiving at least one of program status data from the MCS and feedback data from the motor controller in response to detecting the coupling between the PCS and the machine tool. The program status data is associated with a machining program run by the MCS. The feedback data is associated with the motor. The method also comprises providing at least one of the program status data and the feedback data to the PCS coupled to the machine tool.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a CNC machine tool having a port system for interfacing a PCS with a machine tool, in accordance with various aspects of the subject technology.

FIG. 2 is a block diagram illustrating components of a CNC machine tool having a port system for interfacing a PCS with a machine tool, in accordance with various aspects of the subject technology.

FIG. 3 illustrates an example of a method for interfacing a PCS with a machine tool, in accordance with various aspects of the subject technology.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

According to various aspects of the subject technology, a CNC machine tool with a removable portable control system (PCS) is provided. The PCS provides functionality for handling computationally intensive operations (e.g., providing input/output, user interface, and networking functionality, performing calculations, running simulations, displaying data, generating machining programs that comprise programmed commands, etc.). Although the PCS is removable from the machine tool portion of the CNC machine tool, the machine tool comprises a separate machine control system (MCS) and motor controller that handle less computationally intensive operations compared to the PCS (e.g., receiving the machining programs, executing the programmed commands of the machining programs to perform machining operations, monitoring the status of the execution of the programmed commands, providing feedback data, etc.). Since the PCS is removable, the same PCS may provide the same functionality for other machine tools that do not have their own control systems capable of handling the computationally intensive operations. Thus, the PCS allows machine tools to be manufactured without their own dedicated control systems for handling computationally intensive operations, thereby reducing the cost of manufacturing such machine tools.

According to various aspects of the subject technology, a port system is provided to interface the PCS with the machine tool. The port system is used to facilitate the transfer of data between the PCS and the machine tool. For example, the port system couples the PCS to the machine tool. The PCS can transmit a machining program (comprising one or more commands to operate a motor of the machine tool) to the machine tool via the port system. The machine tool can also provide program status data associated with the machining program and/or feedback data associated with the motor of the machine tool to the PCS via the port system.

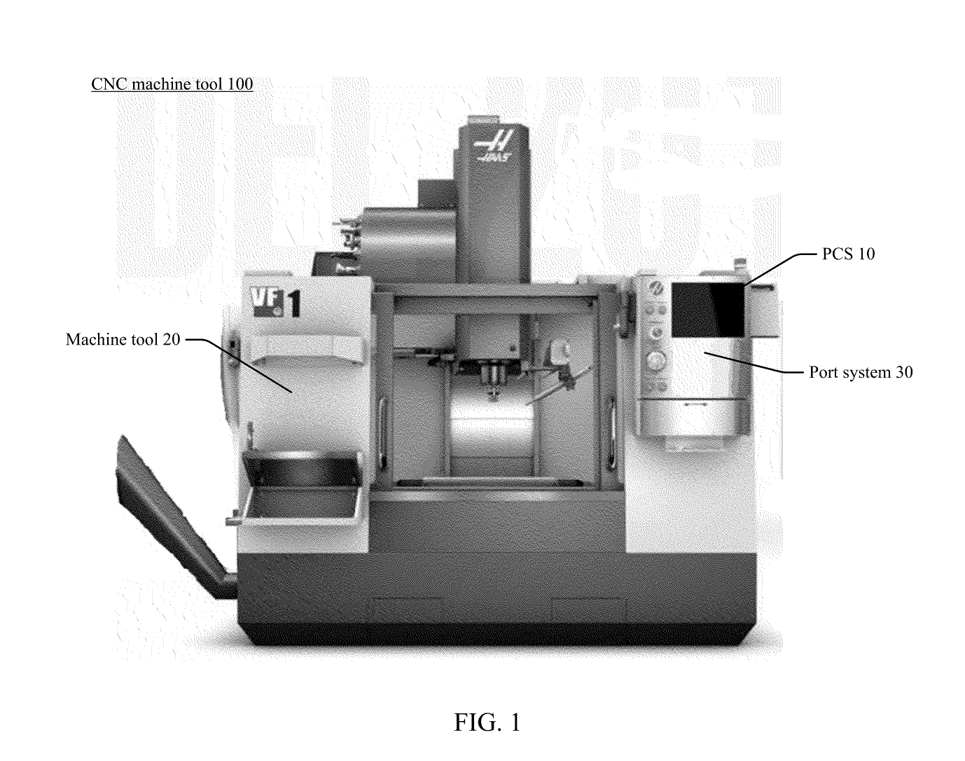

FIG. 1 illustrates an example of CNC machine tool 100 having port system 30 for interfacing PCS 10 with machine tool 20, in accordance with various aspects of the subject technology. Port system 30 is physically attached to machine tool 20 (e.g., port system 30 may be integrally formed with machine tool 20). As discussed above, port system 30 is used to couple PCS 10 to machine tool 20. For example, port system 30 may include a slot in which PCS 10 can be inserted so that PCS 10 can be coupled to machine tool 20. As shown in FIG. 1, PCS 10 is inserted into such a slot to allow PCS 10 to be coupled to machine tool 20. PCS 10 may also be removed from this slot to decouple PCS 10 from machine tool 20. Although PCS 10 is shown in FIG. 1 as a tablet computer, PCS 10 may be a laptop computer, a mobile phone, a personal digital assistant, a netbook computer, and/or other portable electronic device capable of handling the computationally intensive operations discussed above.

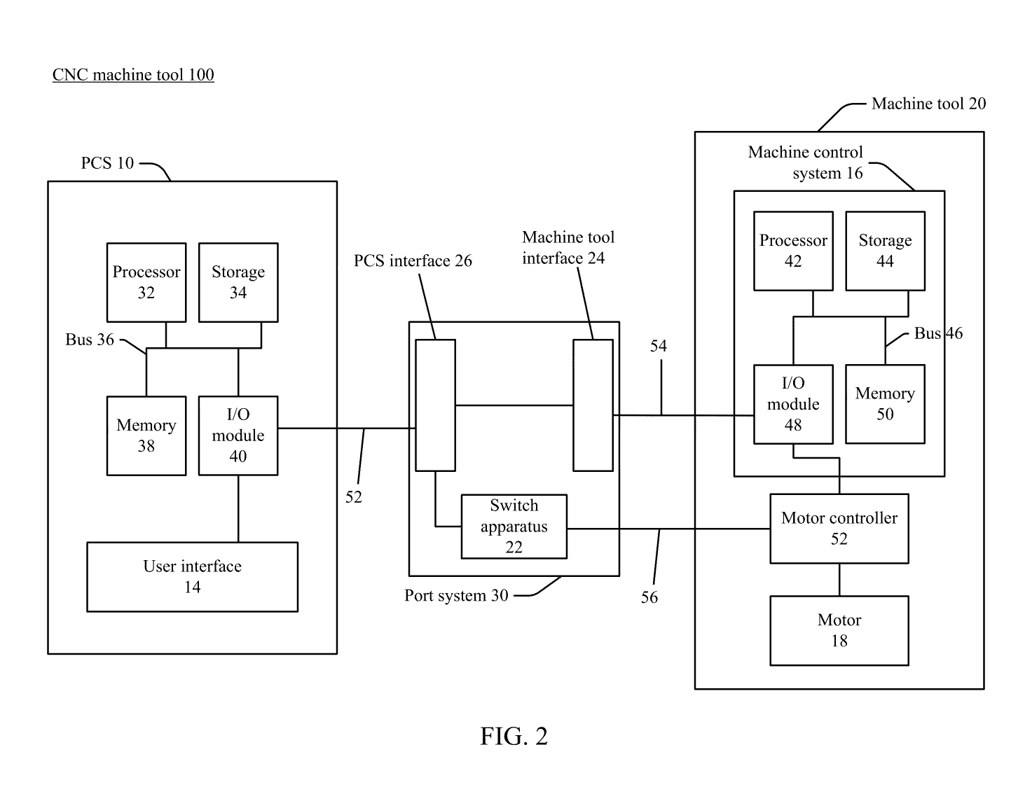

FIG. 2 is a block diagram illustrating components of CNC machine tool 100 having port system 30 for interfacing PCS 10 with machine tool 20, in accordance with various aspects of the subject technology. As shown in FIG. 2, CNC machine tool 100 comprises PCS 10, port system 30, and machine tool 20.

PCS 10 comprises processor module 32, storage module 34, input/output (I/O) module 40, memory module 38, and bus 36. Bus 36 may be any suitable communication mechanism for communicating information. Processor module 32, storage module 34, I/O module 40, and memory module 38 are coupled with bus 36 for communicating information between any of the modules of PCS 10 and/or information between any of these modules and a device coupled to I/O module 40. For example, information communicated between any of the modules of PCS 10 may include instructions and/or data. In some aspects, bus 36 may be a universal serial bus. In some aspects, bus 36 may provide Ethernet connectivity.

Processor module 32 may comprise one or more processors, where each processor may perform different functions or execute different instructions and/or processes. For example, one or more processors may execute instructions for handling computationally intensive operations (e.g., providing input/output, user interface, and networking functionality, performing calculations, running simulations, displaying data, generating machining programs that comprise programmed commands, etc.) for machine tool 20, and one or more processors may execute instructions for input/output functions.

Memory module 38 may be random access memory (“RAM”) or other dynamic storage devices for storing information and instructions to be executed by processor module 32. Memory module 38 may also be used for storing temporary variables or other intermediate information during execution of instructions by processor module 32. In some aspects, memory module 38 may comprise battery-powered static RAM, which stores information without requiring power to maintain the stored information. Storage module 34 may be a magnetic disk or optical disk and may also store information and instructions. In some aspects, storage module 34 may comprise hard disk storage or electronic memory storage (e.g., flash memory). In some aspects, memory module 38 and storage module 34 are both a machine-readable medium.

Processor module 32, storage module 34, and memory module 38 are coupled via I/O module 40 to user interface 14 for providing information to and receiving information from an operator of CNC machine tool 100. For example, user interface 14 may be a cathode ray tube (“CRT”) or LCD monitor for displaying information to the operator. User interface 14 may also include, for example, a keyboard, a mouse, a touchpad, a touch screen, and/or other device for communicating information and command selections to processor module 32 (e.g., via I/O module 40). For example, the operator of CNC machine tool 100 may use PCS 10 to generate a machining program by providing one or more inputs via user interface 14.

According to various aspects of the subject technology, processor module 32 executes instructions for handling computationally intensive operations for machine tool 20 (e.g., providing input/output, user interface, and networking functionality, performing calculations, running simulations, displaying data, generating programmed commands, etc.). Specifically, processor module 32 executes one or more sequences of instructions contained in memory module 38 and/or storage module 34. In one example, instructions may be read into memory module 38 from another machine-readable medium, such as storage module 34. In another example, instructions may be read directly into memory module 38 from I/O module 40, for example from the operator of CNC machine tool 100 via user interface 14. Execution of the sequences of instructions contained in memory module 38 and/or storage module 34 causes processor module 32 to perform the computationally intensive operations for machine tool 20. For example, a computational algorithm for performing the computationally intensive operations may be stored in memory module 38 and/or storage module 34 as one or more sequences of instructions. Information such as machining programs, program status data, feedback data, identification information of machine tools, termination signals, reset signals, start signals, hold signals, and/or other information for operating CNC machine tool 100 may be communicated from processor module 32 to memory module 38 and/or storage module 34 via bus 36 for storage. In some aspects, the information may be communicated from processor module 32, memory module 38, and/or storage module 34 to I/O module 40 via bus 36. The information may then be communicated from I/O module 40 to the operator of CNC machine tool 100 via user interface 14.

One or more processors in a multi-processing arrangement may also be employed to execute the sequences of instructions contained in memory module 38 and/or storage module 34. In some aspects, hard-wired circuitry may be used in place of or in combination with software instructions to implement various aspects of the subject technology. Thus, aspects of the subject technology are not limited to any specific combination of hardware circuitry and software.

Port system 30 couples PCS 10 to machine tool 20. Machine tool 20 comprises machine control system (MCS) 16, motor controller 52, and motor 18. MCS 16 and motor controller 52 may handle less computationally intensive operations compared to PCS 10 (e.g., receiving the machining programs, executing the programmed commands of the machining programs to perform machining operations, monitoring the status of the execution of the programmed commands, providing feedback data, etc.). For example, MCS 16 receives a machining program, which comprises one or more commands to operate motor 18, from PCS 10 via port system 30. MCS 16 may provide a command at a time to motor controller 52, which in turn executes the command to operate motor 18. Motor 18, for example, can be coupled to a tool (e.g., a drill or a saw) for operating on a workpiece. Motor controller 52 may generate feedback data associated with motor 18 (e.g., position of motor 18, speed of motor 18, acceleration of motor 18, rotation of motor 18, etc.), while MCS 16 may generate program status data associated with the machining program (e.g., a current command being executed by motor controller 52, a previous command executed by motor controller 52, a next command to be executed by motor controller 52, etc.). Although motor controller 52 is shown in FIG. 2 as separate from MCS 16, motor controller 52 may also be part of MCS 16 according to certain aspects of the subject technology.

MCS 16 comprises processor module 42, storage module 44, input/output (I/O) module 48, memory module 50, and bus 46. Bus 46 may be any suitable communication mechanism for communicating information. Processor module 42, storage module 44, I/O module 48, and memory module 50 are coupled with bus 46 for communicating information between any of the modules of MCS 16 and/or information between any module of MCS 16 and a device external to MCS 16. For example, information communicated between any of the modules of MCS 16 may include instructions and/or data. In some aspects, bus 46 may be a universal serial bus. In some aspects, bus 46 may provide Ethernet connectivity.

Processor module 42 may comprise one or more processors, where each processor may perform different functions or execute different instructions and/or processes. For example, one or more processors may execute instructions for performing some of the less computationally intensive operations (e.g., receiving the machining programs, providing the programmed commands of the machining programs to motor controller 52, monitoring the status of the execution of the programmed commands, generating program status data, etc.), and one or more processors may execute instructions for input/output functions.

Memory module 50 may be RAM or other dynamic storage devices for storing information and instructions to be executed by processor module 42. Memory module 50 may also be used for storing temporary variables or other intermediate information during execution of instructions by processor module 42. In some aspects, memory module 50 may comprise battery-powered static RAM, which stores information without requiring power to maintain the stored information. Storage module 44 may be a magnetic disk or optical disk and may also store information and instructions. In some aspects, storage module 44 may comprise hard disk storage or electronic memory storage (e.g., flash memory). In some aspects, memory module 50 and storage module 44 are both a machine-readable medium.

MCS 16 is coupled, via I/O module 48, to port system 30, which in turn is coupled to I/O module 40, which is coupled to user interface 14. Thus, if PCS 10 is coupled to machine tool 20, MCS 16 may provide information to and receive information from the operator of CNC machine tool 100 via user interface 14 of PCS 10.

According to various aspects of the subject technology, some of the less computationally intensive operations are executed by MCS 16. Specifically, processor module 42 executes one or more sequences of instructions contained in memory module 50 and/or storage module 44. In one example, instructions may be read into memory module 50 from another machine-readable medium, such as storage module 44. In another example, instructions may be read directly into memory module 50 from I/O module 48, for example from the operator of CNC machine tool 100 via user interface 14. Execution of the sequences of instructions contained in memory module 50 and/or storage module 44 causes processor module 42 to perform some of the less computationally intensive operations. For example, a computational algorithm for performing these operations may be stored in memory module 50 and/or storage module 44 as one or more sequences of instructions. Information such as machining programs, program status data, feedback data, termination signals, reset signals, start signals, hold signals, and/or other information for operating CNC machine tool 100 may be communicated from processor module 42 to memory module 50 and/or storage module 44 via bus 46 for storage. In some aspects, the information may be communicated from processor module 42, memory module 50, and/or storage module 44 to I/O module 48 via bus 46. The information may then be communicated from I/O module 48 to the operator of CNC machine tool 100 via user interface 14.

One or more processors in a multi-processing arrangement may also be employed to execute the sequences of instructions contained in memory module 50 and/or storage module 44. In some aspects, hard-wired circuitry may be used in place of or in combination with software instructions to implement various aspects of the subject technology. Thus, aspects of the subject technology are not limited to any specific combination of hardware circuitry and software.

As discussed above, port system 30 couples PCS 10 to machine tool 20. Port system 30 is used to facilitate communication between PCS 10 and machine tool 20. Port system 30 comprises PCS interface 26 and machine tool interface 24, which are coupled to one another. Machine tool interface 24 is coupled to I/O module 48 of MCS 16, while PCS interface 26 is coupled to I/O module 40 of PCS 10. Port system 30 may facilitate communication between PCS 10 and machine tool 20 by allowing data to be transmitted from PCS 10 to PCS interface 26 to machine tool interface 24 to MCS 16, as well as from MCS 16 to machine tool interface 24 to PCS interface 26 to PCS 10. Port system 30 also comprises switch apparatus 22, which is implemented as an emergency stop switch to halt the operation of machine tool 20.

PCS interface 26 is coupled to I/O module 40 of PCS 10 via communication link 52. Communication link 52, for example, may be a universal serial bus link, an IEEE 1394 high speed serial bus link (e.g., FireWire), a basic serial bus link, a parallel communication link, an Ethernet communication link, and/or other physical link for facilitating communication between PCS 10 and port system 30. In some aspects, communication link 52 may be a wireless link, such as a Bluetooth link, an infrared link, a near field communication (NFC) link, a wireless local area network (LAN) link, a ZigBee link, and/or other wireless link for facilitating communication between PCS 10 and port system 30. However, if communication link 52 is a wireless link, then PCS 10 should preferably be used within a short range of port system 30 and machine tool 20 for safety reasons (e.g., so that the operator of CNC machine tool 100 can monitor the operation of machine tool 20 while using PCS 10). Depending on what communication link 52 may be, PCS interface 26 may comprise a port for connecting to communication link 52 (e.g., if communication link 52 is a physical link) and/or an antenna for establishing communication link 52 (e.g., if communication link 52 is a wireless link).

Machine tool interface 24 is coupled to I/O module 48 of MCS 16 via communication link 54. Communication link 54 may be the same type of link that communication link 52 may be. However, since port system 30 is preferably physically attached to machine tool 20 (e.g., port system 30 is integrally formed with machine tool 20), communication link 54 is preferably a physical link. Depending on what communication link 54 may be, machine tool interface 24 may comprise a port for connecting to communication link 54 (e.g., if communication link 54 is a physical link) and/or an antenna for establishing communication link 54 (e.g., if communication link 54 is a wireless link).

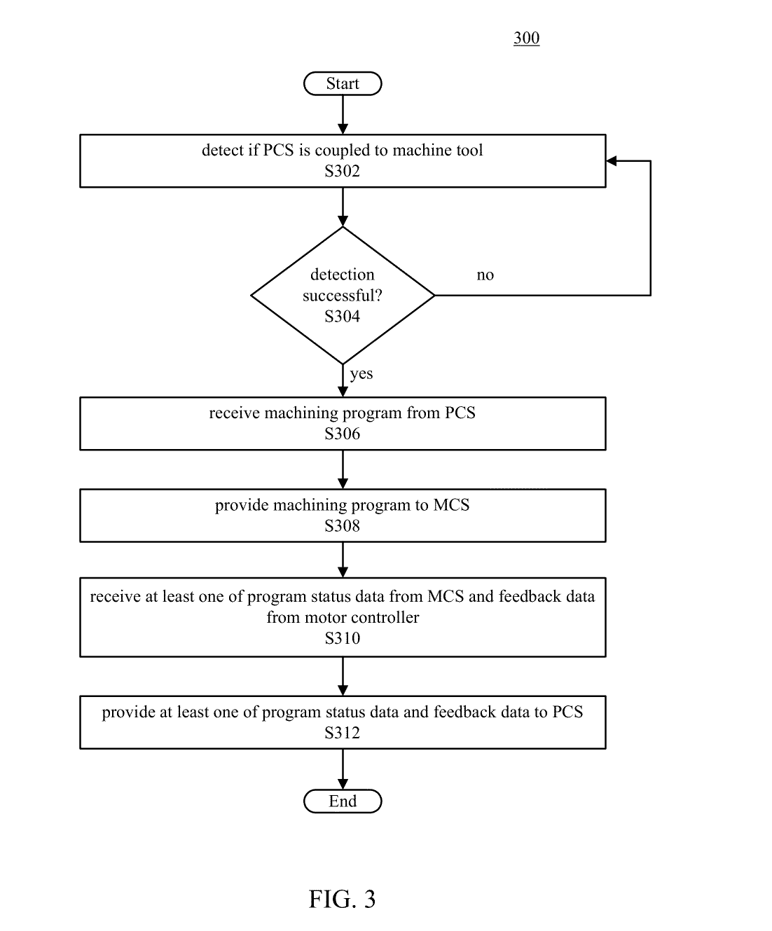

FIG. 3 illustrates an example of method 300 for interfacing PCS 10 with machine tool 20, in accordance with various aspects of the subject technology. Referring to FIGS. 2 and 3, according to step S302, port system 30 detects if PCS 10 is coupled to machine tool 20. PCS 10 may be considered coupled to machine tool 20, if communication link 52 is successfully established between I/O module 40 of PCS 10 and PCS interface 26 of port system 30. In one example, when PCS 10 is inserted into the slot of port system 30, either PCS 10 comprises a connector that connects to the port of PCS interface 26 or PCS 10 becomes within range of the antenna of PCS interface 26 and the operator indicates a desire to connect to machine tool 20 via user interface 14. When such an event occurs, a handshaking protocol between PCS 10 and machine tool 20 via port system 30 may be initiated to establish communication link 52. According to the handshaking, PCS 10 may transmit a connection request to machine tool 20 via port system 30. In response to this connection request, machine tool 20 may transmit a connection acknowledgement back to PCS 10 via port system 30. Machine tool 20 may also send identification information of machine tool 20 to PCS 10 during the handshaking. After PCS 10 and machine tool 20 have both acknowledged and verified the connection between one another, communication link 52 may be considered established. In some aspects, when communication link 52 is established, an electrical and/or mechanical switch may be activated, which may generate a signal indicating that PCS 10 is coupled to machine tool 20. Thus, port system 30 is able to detect that PCS 10 is coupled to machine tool 20 based on such a signal. According to steps S302 and S304, if the detection is not successful, then port system 30 may continue detecting if PCS 10 is coupled to machine tool 20.

According to steps S304 and S306, if the detection is successful, then port system 30 receives a machining program from PCS 10. As discussed above, PCS 10 may be used to perform various computationally intensive operations. For example, PCS 10 may generate the machining program based on user input received via user interface 14. The user input may specify how the operator desires to operate machine tool 20. The machining program comprises one or more commands that, when executed by motor controller 52, allows machine tool 20 to be operated according to how the operator desires to operate machine tool 20. For example, the one or more commands may indicate what position, speed, acceleration, and/or rotation that motor 18 should operate at in order to perform a particular machining operation. Motor controller 52 may execute these commands to operate machine tool 20, such as by controlling motor 18 to achieve the position, speed, acceleration, and/or rotation specified by the commands.

If PCS 10 receives identification information of machine tool 20 during the handshaking described in step S302, PCS 10 may select a machining program specific to machine tool 20 (e.g., from a library of machining programs maintained in PCS 10, with each machining program corresponding to a different machine tool) and provide such a machining program to machine tool 20 via port system 30. In some aspects, the machining program may be generated by copying other machining programs corresponding to other machine tools. For example, because different machining programs can be stored in PCS 10, processor 32 may copy machining programs corresponding to other machine tools to generate the machining program corresponding to machine tool 20. PCS 10 may also allow the operator to modify the machining program. For example, the operator may make changes to the machining program via user interface 14. Furthermore, PCS 10 may allow the operator to simulate an operation of machine tool 20 based on the machining program, and display any results of the simulation via user interface 14. The simulation may be helpful to the operator when generating and/or modifying the machining program. For example, based on the simulation, the operator may be able to decide whether to continue to use the generated machining program to achieve results similar to the simulation or modify the machining program to achieve different results.

PCS interface 26 receives the machining program from PCS 10 via communication link 52. According to step S308, port system 30 provides the machining program to MCS 16. In particular, PCS interface 26 provides the machining program to machine tool interface 24, which provides the machining program to I/O module 48 of MCS 16 via communication link 54. MCS 16 may run the machining program, such as by compiling the machining program and providing a single command at a time to motor controller 52, which executes the command to operate motor 18. For example, motor controller 52 may control motor 18 based on the position, speed, acceleration, and/or rotation specified by the command.

Based on the operation of machine tool 20, motor controller 52 generates feedback data associated with motor 18. The feedback data, for example, may comprise at least one of a position of motor 18, a speed of motor 18, an acceleration of motor 18, an axis of motor 18, a rotation of motor 18, a position of a tool coupled to motor 18, a speed of the tool, an acceleration of the tool, a rotation of the tool, a position of a workpiece operated on by the tool, an orientation of the workpiece, and other information regarding the operation of machine tool 20. Furthermore, based on the operation of machine tool 20, MCS 16 generates program status data associated with the machining program run by MCS 16. The program status data comprises at least one of identification information of machine tool 20, a current command being executed by motor controller 52, a previous command executed by motor controller 52, a next command to be executed by motor controller 52, and other information regarding the status of the machining program.

The program status data and the feedback data can be provided to PCS 10 so that this data may be displayed to the operator of CNC machine tool 100 via user interface 14. In this regard, according to step S310, port system 30 receives at least one of the program status data from MCS 16 and the feedback data from motor controller 52. For example, MCS 16 transmits the program status data to machine tool interface 24 via I/O module 48 and communication link 54. Motor controller 52 also transmits the feedback data to machine tool interface 24 via I/O module 48 and communication link 54.

According to step S312, port system 30 provides at least one of the program status data and the feedback data to PCS 10. For example, PCS interface 26 may receive at least one of the program status data and the feedback data from machine tool interface 24, and provide this data to I/O module 40 via communication link 52. I/O module 40 may provide the data to processor module 32 (e.g., to analyze and process the data), storage module 34 and memory module 38 (e.g., for storage), or to user interface 14 (e.g., to display the data).

According to certain aspects, PCS 10 may not only be used to display the feedback data from machine tool 20, but may also be used to display feedback data from other machine tools. Thus, PCS 10 allows the operator to compare the feedback data from machine tool 20 to feedback data received from other machine tools, which may be helpful for the operator to evaluate the performance of machine tool 20 in comparison to other machine tools. For example, processor module 32 may compare the feedback data from machine tool 20 to feedback data received from other machine tools and generate comparison information that reflects one or more differences in the operation of machine tool 20 and the operation of the other machine tools.

PCS 10 allows the operator to control machine tool 20 primarily through PCS 10. For example, the operator may use PCS 10 to perform the computationally intensive operations in connection with machine tool 20, while allowing MCS 16 and motor controller 52 to perform the less computationally intensive operations. In some aspects, PCS 10 may be removable from machine tool 20 even while machine tool 20 is operating. Thus, the operator may beneficially use PCS 10 to control different machine tools without having to stop the operation of each machine tool should PCS 10 be removed. However, because PCS 10 is removable, a number of safety issues may arise.

One safety issue that may arise is in halting the operation of machine tool 20. In a conventional CNC machine tool, a control system that performs the computationally intensive operations is part of the machine tool itself, and therefore, the control system also includes an emergency stop switch to halt the operation of the machine tool should the need to halt the machine tool arise. However, since PCS 10 is removable and machine tool 20 may still operate when PCS 10 is removed, an emergency stop switch as part of PCS 10 is no longer feasible. In this regard, according to various aspects of the subject technology, port system 30 comprises switch apparatus 22, which is implemented as an emergency stop switch to halt the operation of machine tool 20. Switch apparatus 22 is coupled directly to motor controller 52 via communication link 56. Communication link 56 may be the same type of physical link that communication link 52 may be. Thus, switch apparatus 22 may be considered hard-wired to motor controller 52.

Should the operator decide to halt the operation of machine tool 20 (even if PCS 10 is removed from machine tool 20), the operator may activate switch apparatus 22. As a result, switch apparatus 22 may transmit a termination signal to motor controller 52 via communication link 56 to halt the operation of machine tool 20. Motor controller 52 may halt the operation of machine tool 20 upon receiving this termination signal. Furthermore, upon receiving the termination signal, motor controller 52 may prevent execution of any commands received from MCS 16. In some aspects, switch apparatus 22 is also coupled to PCS interface 26, which allows switch apparatus 22 to transmit the termination signal to PCS 10 via PCS interface 26 (if PCS 10 is coupled to machine tool 20). Based on this termination signal, PCS 10 may inform the operator via user interface 14 that operation of machine tool 20 is halted.

Although port system 30 is shown in FIG. 3 as having only switch apparatus 22 as a switch, port system 30 may comprise other switches that provide different functionality for the user. For example, port system 30 may comprise a reset switch that, when activated by the operator, may transmit a reset signal to motor controller 52. Upon receiving the reset signal, motor controller 52 may allow the execution of commands received from MCS 16. In some aspects, port system 30 may comprise a start switch that, when activated by the operator, may transmit a start signal to motor controller 52. Upon receiving the start signal, motor controller 52 may initiate the operation of machine tool 20. The reset switch and the start switch may be activated to restart the operation of machine tool 20 should its operation be halted. In some aspects, port system 30 may comprise a feedhold switch that, when activated by the operator, may transmit a hold signal to motor controller 52. Upon receiving the hold signal, motor controller 52 may maintain the operation of machine tool 20 for a predetermined duration. The feedhold switch, for example, may include dials for different values for the predetermined duration, thereby allowing the operator to select a certain value for the predetermined duration. Any of the reset, start, and hold signals may also be transmitted to PCS 10 via PCS interface 26 and communication link 52 to provide verification to the operator that the corresponding switches have been activated.

Another safety issue that may arise is when PCS 10 is coupled to an already operating machine tool 20. Thus, should PCS 10 provide machine tool 20 with a new machining program (one that is different from a machining program that machine tool 20 is currently executing), machine tool 20 may potentially halt its operation immediately in an attempt to begin executing the new machining program. However, halting the operation of machine tool 20 in this manner may be dangerous, especially if machine tool 20 is currently engaged in a machining operation that may cause injury to the operator and/or damage to machine tool 20 if the operation is halted immediately (e.g., machine tool 20 may be performing a machining operation on a workpiece, and immediately halting such an operation may cause the workpiece to be violently disengaged from machine tool 20). Thus, according to various aspects of the subject technology, port system 30 may facilitate a negotiation process between PCS 10 and machine tool 20 in order to allow PCS 10 to safely interrupt an operation of machine tool 20.

For example, according to the negotiation process, PCS 10 may transmit an interrupt request to MCS 16 via port system 30. In particular, the interrupt request may be transmitted from PCS 10 to PCS interface 26 (via communication link 52), which may transmit the interrupt request to machine tool interface 24, which may transmit the interrupt request to MCS 16 (via communication link 54). Based on this interrupt request, MCS 16 may provide a command to motor controller 52 to halt an operation of motor 18. However, MCS 16 may only provide this command to motor controller 52 when it is safe to do so. For example, MCS 16 may provide this command to motor controller 52 only after motor controller 52 has completed an execution of a current command. Thus, the operation of machine tool 20 would not be immediately halted if PCS 10 provides a new machining program to machine tool 20 when machine tool 20 is already implementing an existing machining program.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The term “machine-readable medium,” or “computer-readable medium,” as used herein, refers to any medium that participates in providing instructions to processor module 32 and/or processor module 42 for execution. Such a medium may take many forms, including, but not limited to, non-volatile media and volatile media. Non-volatile media include, for example, optical or magnetic disks, such as storage module 34 and/or storage module 44. Volatile media include dynamic memory, such as memory module 38 and/or memory module 50. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer numerical controlled (CNC) machine tool comprising:
a machine tool having a motor, a machine control system (MCS), and a motor controller, the MCS being configured to generate program status data associated with a machining program run by the MCS, the motor controller being configured to generate feedback data associated with the motor; and
a port system configured to couple a portable control system (PCS) to the machine tool,
wherein the port system is configured to detect when the PCS is coupled to the machine tool and to provide at least one of the program status data and the feedback data to the PCS in response to the detection of the PCS being coupled to the machine tool.

2. The CNC machine tool of claim 1, wherein the port system is configured to receive the machining program from the PCS and to provide the machining program to the MCS.

3. The CNC machine tool of claim 1, wherein the machining program comprises one or more commands to operate the motor.

4. The CNC machine tool of claim 1, wherein the program status data comprises at least one of identification information of the machine tool, a current command being executed by the motor controller, a previous command executed by the motor controller, and a next command to be executed by the motor controller.

5. The CNC machine tool of claim 1, wherein the feedback data comprises at least one of a position of the motor, a speed of the motor, an acceleration of the motor, an axis of the motor, a rotation of the motor, a position of a tool coupled to the motor, a speed of the tool, an acceleration of the tool, a rotation of the tool, a position of a workpiece operated on by the tool, and an orientation of the workpiece.

6. The CNC machine tool of claim 1, wherein the port system comprises:
a machine tool interface coupled to the MCS;
a PCS interface coupled to the machine tool interface, the PCS interface being configured to couple to the PCS and to receive the machining program from the PCS, the machine tool interface being configured to provide the machining program to the MCS; and
a switch apparatus coupled to the motor controller, the switch apparatus being configured to receive user input and to transmit a termination signal to the motor controller to halt the operation of the machine tool based on the user input.

7. The CNC machine tool of claim 6, wherein the switch apparatus is hard-wired to the motor controller.

8. The CNC machine tool of claim 6, wherein the switch apparatus is coupled to the PCS interface, the PCS interface being configured to provide the termination signal to the PCS.

9. A computer numerical controlled (CNC) machine tool comprising:
a machine tool having a machine control system (MCS);
a portable control system (PCS) configured to generate a machining program run by the MCS, the MCS being configured to generate program status data associated with the machining program; and
a port system configured to couple the PCS to the machine tool,
wherein the port system is configured to detect when the PCS is coupled to the machine tool and to provide the program status data to the PCS in response to the detection of the PCS being coupled to the machine tool.

10. The CNC machine tool of claim 9, wherein the machine tool further comprises a motor and a motor controller, the motor controller being configured to generate feedback data associated with the motor.

11. The CNC machine tool of claim 10, wherein the port system is configured to provide the feedback data to the PCS in response to the detection of the PCS being coupled to the machine tool.

12. The CNC machine tool of claim 11, wherein the PCS is configured to display at least one of the program status data and the feedback data to a user via a user interface of the PCS.

13. The CNC machine tool of claim 9, wherein the PCS comprises at least one of a laptop computer, a tablet computer, a mobile phone, a personal digital assistant, and a netbook computer.

14. The CNC machine tool of claim 9, wherein the PCS is configured to receive user input via a user interface of the PCS, the PCS being configured to generate the machining program based on the user input.

15. The CNC machine tool of claim 9, wherein the PCS is configured to simulate an operation of the machine tool based on the machining program.

16. The CNC machine tool of claim 9, wherein the PCS is configured to transmit an interrupt request to the MCS via the port system.

17. The CNC machine tool of claim 16, wherein the MCS is configured to halt an operation of the machine tool based on the interrupt request.

18. The CNC machine tool of claim 17, wherein the MCS is configured to halt the operation of the machine tool based on the interrupt request only after a motor controller of the machine tool completes an execution of a current command.

19. A method for interfacing a portable control system (PCS) with a machine tool, the method comprising:
detecting a coupling between the PCS and the machine tool, the machine tool having a motor, a machine control system (MCS), and a motor controller;
receiving at least one of program status data from the MCS and feedback data from the motor controller in response to detecting the coupling between the PCS and the machine tool, the program status data being associated with a machining program run by the MCS, the feedback data being associated with the motor; and
providing at least one of the program status data and the feedback data to the PCS coupled to the machine tool.

20. The method of claim 19, further comprising:
receiving the machining program from the PCS; and
providing the machining program to the MCS.
